(19) United States
(12) Patent Application Publication
(10) Pub. No.: US 2012/0293078 A1
(43) Pub. Date: Nov. 22, 2012

(54) LED Driver Including Color Monitoring

(75) Inventors: Andrea Logiudice, Padova (IT); Fabrizio Donà, Due Carrare (PD) (IT)

(73) Assignee: Infineon Technologies Austria AG, Villach (AT)

(21) Appl. No.: 13/112,495

(22) Filed: May 20, 2011

(51) Int. Cl. H05B 37/02

(52) U.S. Cl. 315/153; 315/152

(57) ABSTRACT

A circuit provided for driving a multi-color LED assembly includes at least two LEDs operable to emit light of different color. The circuit includes a control and processing unit that is configured to select a source LED and a sensor LED from the LEDs of the multi-color LED assembly. A sensor unit is associated with the sensor LED and is configured to obtain a current measurement value representing the photo current provided by the sensor LED when receiving incident light emitted by the source LED. A LED driver unit is associated with the source LED and is configured to provide load current to the source LED in accordance with a corresponding input value.

### TECHNICAL FIELD

The invention relates to the field of driver circuits for light emitting diodes (LEDs), in particular, to driver circuits for LED assemblies including a plurality of LEDs.

### BACKGROUND

The brightness of light emitting diodes (LEDs) is directly dependent on the load current flowing through the diode. To vary the brightness of an LED it is known to use a controllable current source that is set to a current representing a desired brightness. In digitally controlled applications a digital-to-analog converter (DAC) may be used to set the current of the controllable current source which operates as an LED driver.

It is known to combine light of different colors (e.g., red, green, and blue) and different brightness to generate nearly any color sensation in the visible spectrum of light. In modern illumination systems or displays a combination of at least three LEDs of different colors are used to provide a multi-color illumination. The LED-triples may be arranged in a matrix like structure thus forming a display where each “pixel” of the display is represented by an LED-triple typically comprising a red, a green, and a blue LED. To vary the color of a pixel the brightness of the different LEDs has to be individually adjustable. More sophisticated LED assemblies include four LEDs of different color, such as red, green, blue, and white (RGBW LED assembly) or red, green, blue, and yellow (RGBY LED assembly).

The fact that the luminous flux (also luminous power) generated by a single LED directly depends on the load current of the LED does not mean that the relation between luminous flux and the corresponding LED forward current is stable. In fact, the ratio between the generated luminous flux and the corresponding LED forward current may vary due to production tolerances, due to temperature variations, as well as due to drift resulting from ageing effects. Such variations of the luminous flux generated by a single LED cannot be avoided when the LED is driven with a defined (constant) current. In a multi-color LED assembly, which includes at least two LEDs generating light of different color, such variations of the luminous flux generated by one LED (or, in other words, variations of the luminous intensity of the respective LED) entail a respective variation of the resulting color due to additive color mixing of the light emitted by the LEDs of the multi-color LED assembly. Such variation may be perceived as distracting variations of hue or saturation.

Thus there is a need for a multi-color LED assembly including a so-called color-point stabilization by stabilizing the luminous intensity of each LED included.

### SUMMARY OF THE INVENTION

A circuit for driving an LED assembly is disclosed. Such an LED assembly comprises at least two LEDs operable to emit light providing a luminous flux depending on the respective load current. The circuit comprises a control and processing unit configured to select from the LEDs of the LED assembly a source LED and a sensor LED. A sensor unit associated with the sensor LED is configured to obtain a current measurement value representing the photo current provided by the sensor LED when receiving incident light emitted by the source LED. A LED driver unit is associated with the source LED and configured to provide load current to the source LED in accordance with a corresponding input value. A corresponding method for driving an LED assembly is disclosed.

### BRIEF DESCRIPTION OF THE DRAWINGS

The invention can be better understood with reference to the following drawings and description. The components in the figures are not necessarily to scale, instead emphasis being placed upon illustrating the principles of the invention. Moreover, in the figures, like reference numerals designate corresponding parts. In the drawings:

FIG. 1 illustrates the principle of optical feed-back in an LED assembly;

FIG. 2 illustrates a multi-color LED assembly including four LEDs of different color, each one may be operated either as a light emitting diode or as a photo diode;

FIG. 3 illustrates parts of the multi-color LED assembly of FIG. 2 in more detail;

FIG. 4 illustrates in a diagram the relation between LED load current and resulting photo-current for different pairs of LEDs wherein one LED is operating as a photo diode;

FIG. 5 illustrates an exemplary calibration table generated during an initial calibration process; and

FIG. 6 is a flow chart illustrating the calibration process.

### DETAILED DESCRIPTION OF ILLUSTRATIVE EMBODIMENTS

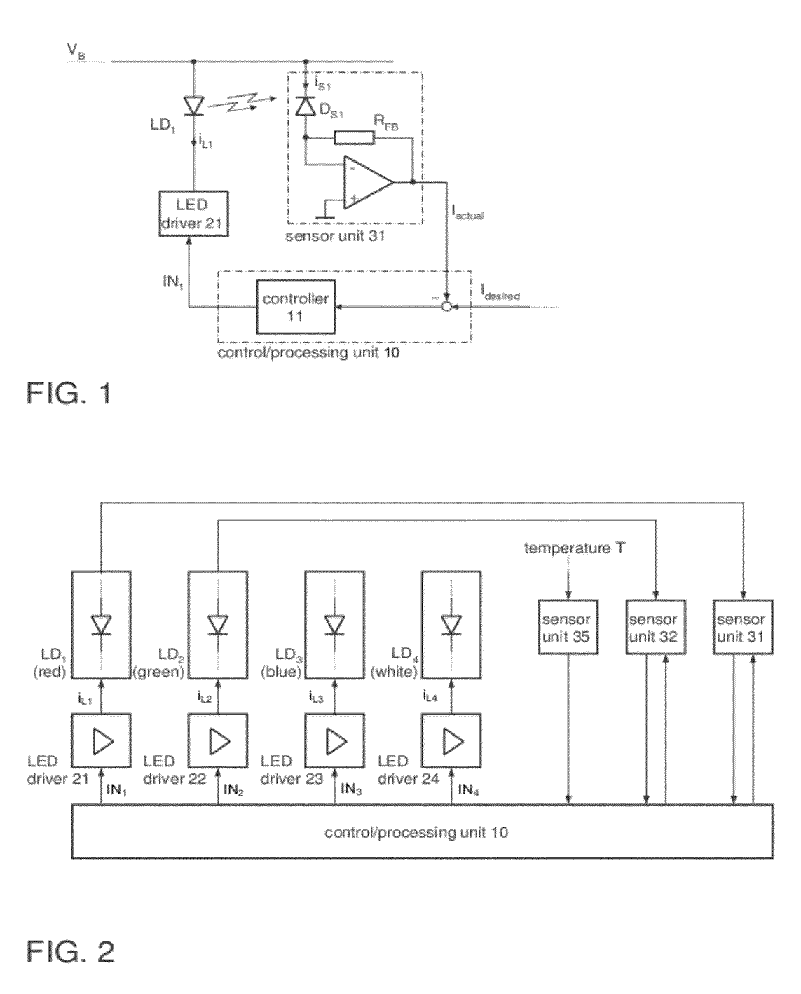

In a multi-color LED assembly, which includes at least two LEDs generating light of different color, variations of the luminous flux generated by one LED (i.e., variations of the luminous intensity provided the respective LED) entail a respective variation of the resulting color. Such variation may be perceived as distracting variations of hue or saturation. In order to reduce such intensity variation of an LED an optical feedback may be provided to the driver circuit controlling the load current of the respective LED. FIG. 1 illustrates the principle of such an optical feed-back loop (control loop) for stabilizing the luminous intensity provided by an individual LED.

Accordingly, an LED device LD₁ is driven by an adequate LED driver 21 which sets the load current i_{L1} of the LED LD₁ in accordance with an input signal IN₁ provided to the LED driver 21 by a control unit 10. In order to facilitate an optical feed-back a photo sensor unit 31 is arranged adjacent to the LED LD₁ and optically coupled thereto. The output signal I_{actual} of the sensor unit 31 represents the actually present luminous intensity currently provided by the LED LD₁. In the present example, the photo sensor unit 31 includes a photo diode D_{S1} whose output current (sensor current i_{S1}) is amplified by a transimpedance amplifier that provides the output signal I_{actual} which is, in the present example, a voltage proportional to the amplifier input current i_{S1}. The output signal I_{actual} is provided to the control unit 10 as well as a reference signal I_{desired} that represents the desired luminous intensity to be provided by the LED LD1. The control unit 10 is configured to form an error signal I_{desired}-I_{actual}, which is provided to a controller 11 (e.g., a P-controller) included in the control unit 10. The controller 11 provides the input signal IN₁ supplied to the LED driver 21, and thereby, the feed-back loop is closed. The controller 11 is configured to provide the driver input signal IN₁ in response to the error signal I_{desired}-I_{actual} in accordance with a pre-defined control law. For example, the controller 11 may be a P-controller or a PI-controller. However, other control characteristics may be applicable.

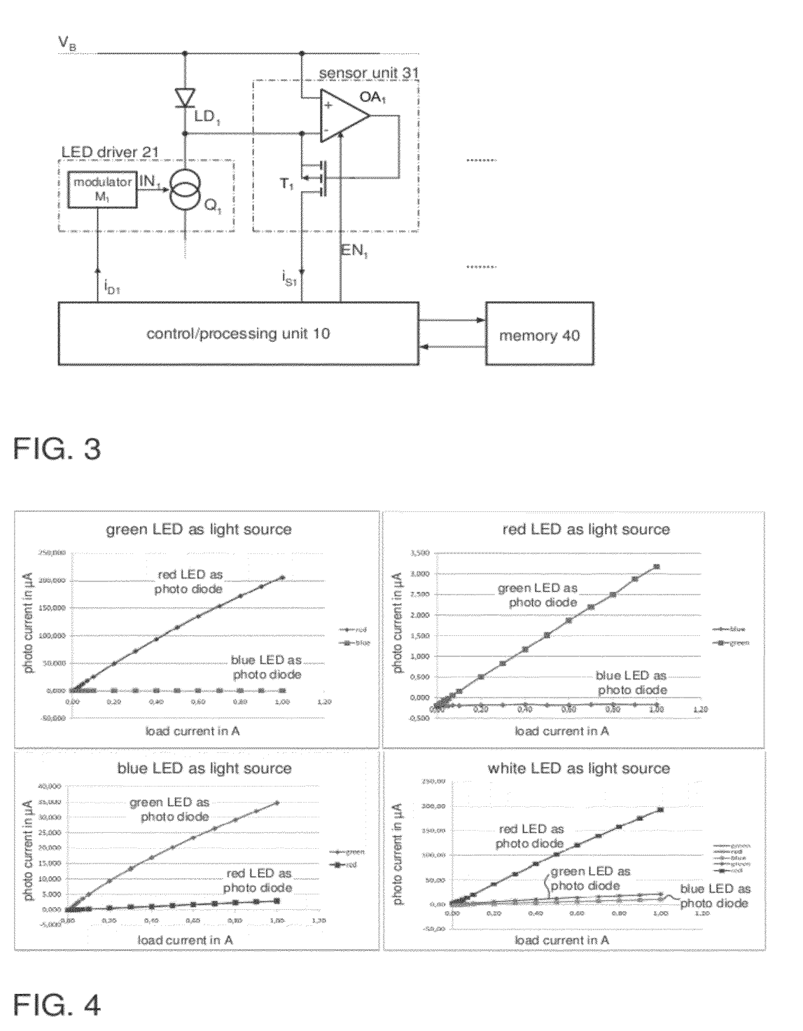

In a multi-color LED assembly the optical feed-back may be usefully employed to stabilize the color-point (i.e., hue, brightness, and saturation) of the light provided by the LED assembly. The sensor unit 31 illustrated in the example of FIG. 1 may be “shared” between two or more LEDs (using a multiplexer) so that only one single photo diode (or other light sensitive sensor element) is required in one multi-color LED assembly. However, the multi-color LED assembly can be further simplified when operating an LED temporarily as photo diode for measuring the luminous intensity provided by another LED in the assembly. Examples of such an improved multi-color LED assembly are discussed below with reference to FIGS. 2 and 3.

FIG. 2 illustrates the structure of one exemplary multi-color LED assembly in accordance with one example of the invention. The multi-color LED assembly of FIG. 2 is a RGBW assembly and thus includes a red LED device LD₁, a green LED device LD₂, a blue LED device LD₃, and a white LED device LD₄. Each of the LED devices LD₁, LD₂, LD₃, and LD₄ is driven by a corresponding LED driver unit 21, 22, 23, and 24, respectively. The LED driver units 21, 22, 23, and 24 provide load currents i_{L1}, i_{L2}, I_{L3}, and i_{L4} to the associated LED devices LD₁, LD₂, LD₃, and LD₄ in accordance with input signals IN₁, IN₂, IN₃, and IN₄, respectively, provided by a control unit 10. The input signals IN₁, IN₂, IN₃, and IN₄ depend on an optical feed-back provided by one of the sensor units 31 and 32 coupled to the LEDs LD₁ and LD₂.

For providing an optical feed-back, the luminous intensity of each individual LED has to be measured. For this purpose, the control unit 10 is configured to schedule a measurement cycle, during which the LED, whose intensity is to be measured, is on and carrying a certain load current i_{Li} and one of the remaining LEDs is operated as a photo diode providing a photo current (sensor current i_{Si}, the subscript i denoting the LED LDᵢ) representing the luminous intensity provided by the active LED. As the response time of the photo diode is typically in the range of a few microseconds (e.g., below 10 μs) such a measurement cycle can be scheduled without adversely affecting the color perception, as the human eye is not able to resolve such short (below, e.g., 100 μs) interruptions which are required for finishing a measurement cycle.

For example, when the red LED LD₁ is active, the green LED LD₂ may be operated as a photo diode. A sensor unit 32 may be associated with the green LED LD₂, wherein the sensor units may include, for example, an amplifier for amplifying the photo current and providing the actual intensity signal I_{actual} (see FIG. 1) which is fed back to the control unit 10. Analogously, the red LED LD₁ may be operated as a photo diode during a measurement cycle in which the green LED LD₂ is active. Experiments have shown that, in practice, it may be sufficient when only two different LEDs are configured to be operable as photo diodes. That is, the red LED LD₁ is operated as photo diode for measuring the luminous intensity of the green and the blue LED LD₂ and LD₃, respectively, and the green LED LD₂ is operated as photo diode for measuring the luminous intensity of the red LED LD₁ and the white LED LD₄. However, the decision which LEDs are best suited as photo diodes may depend on the actual implementation of the LED assembly and the type of diodes used therein. In the example of FIG. 2 two sensor units 31, 32 are shown. One sensor unit 31 coupled with the red LED LD1 and one sensor unit 32 coupled with the green LED LD₂. It should be noted that one sensor unit may be sufficient. In this case the sensor unit may be shared among the LEDs which are operable as photo diodes. For this purpose an analog multiplexer unit (not shown) may be used. Additionally, a further sensor unit 35 may be provided which is configured to provide temperature information to the control unit 10. The temperature of the multi-color LED assembly may be used to further increase accuracy by compensating temperature dependent drift.

FIG. 3 illustrates a part of the example of FIG. 2 in more detail. Only the red LED LD₁ is shown for the ease of illustration. The red LED LD₁ may be operated as light emitting diode or as photo diode. However, the expansion of the part illustrated in FIG. 3 to a full multi-color assembly as illustrated in FIG. 2 should be self-explanatory. Accordingly, an LED driver 21 may include a modulator M₁ for providing a modulated (pulsed) load current to the LED LD₁ wherein the duty cycle of the modulated load current is set such that the average load current corresponds to the driver input signal IN₁. Various modulators may be used in such an application such as pulse-width modulators or pulse density modulators. The sensor unit 31 is connected to the LED LD₁ and configured to provide a signal representing the photo current i_{S1} which is generated by the LED LD₁ in response to incident light stemming from another LED (e.g., LD₂). During such a measurement cycle the LED LD₁ should not be supplied with a load current. In the present example the sensor unit 31 includes an operational amplifier OA₁ and a transistor T₁, both coupled to the LED LD₁ wherein the operational amplifier is connected such that it keeps the bias voltage across the LED (when operating as photo diode) close to zero. The transistor T₁ carries the photo current i_{S1}. Therefore, the gate of the transistor is charged by the amplifier output that the transistor current equals the photo current i_{S1} for a diode bias voltage of zero. A reverse bias voltage may be applied to the sensor LEDs for reducing the junction capacitance and thus increasing the sensor bandwidth. However, this may reduce the achievable accuracy. The control unit 10 is configured to receive the measurement signal from the sensor unit 31 and to enable and disable the sensor unit (via the enable signal EN₁) so that the sensor unit 31 can be switched inactive when the LED LD₁ is operated as light emitting device. The control/processing unit 10 is further configured to subsequently obtain an intensity measurement value I_{actual} for each active LED LD₁ to LD₄ for given load currents and to store the tuples “load current”/“resulting intensity” in a calibration table that resides in a memory 40 which may be included or coupled to the control/processing unit 10.

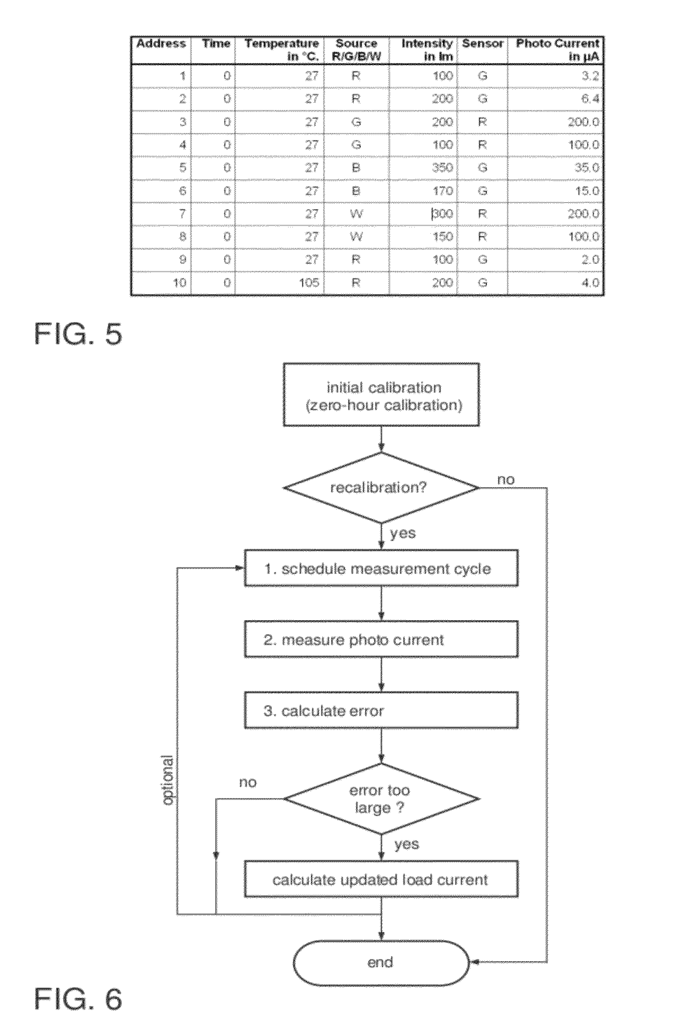

FIG. 4 illustrates the sensitivities of the LEDs when operated as photo diodes. As mentioned above, for the tested multi-color LED assembly the red LED LD₁ and the green LED turned out to be most suitable as photo diodes for the green and the white LED and for the red and the blue LED, respectively. It can be seen from the diagrams of FIG. 4 which LEDs should be combined to achieve the best photo diode sensitivity. The measured sensitivity curves may also be stored in the memory 40 (FIG. 3) so as to allow for a calibration of the photo diode output. An exemplary calibration table generated during an initial calibration is depicted in FIG. 5.

The function of the control and processing unit 10 as well as the corresponding method for stabilizing the color point of the multi-color LED assembly is explained in more detail below. A corresponding flow-chart is depicted in FIG. 6.

Firstly, an initial calibration of the sensor LEDs has to be performed within a final step of the production process (“zero-hour calibration”). Thereby, a defined load current is subsequently supplied to each LED LD₁, LD₂, LD₃, LD₄ and a resulting photo current is measured using the associated sensor LED LD₂ or LD₃. If the relationship between load current and luminous intensity is known for the respective LED, this relation may be used to convert the measured photo current into an intensity value. Direct optical intensity (luminous flux) measurement using a reference sensor may be considered for improved accuracy. The measurement results may be stored in a calibration table residing, for example, in the memory 40 (see FIG. 3). An example of a resulting calibration table is illustrated in FIG. 5.

During normal operation of the multi-color LED assembly from time to time a recalibration may be triggered, the steps which are shown in FIG. 6. This may be every time the LED assembly starts up, or when a certain time has passed since the last calibration, or also in response to certain events such as an over-temperature or the like. If the control unit decides to trigger a recalibration the following steps are performed.

1. A measurement cycle is scheduled. That is, the control unit 10 deactivates all LEDs except the one whose intensity is to be measured. Further, the associated sensor LED is activated.

2. A photo current provided by the sensor LED is sampled after a response time of the sensor LED during which transient currents decay. However, the response time is relatively short, for example, about 10 microseconds.

3. The actually measured photo current is compared with a “desired” photo current known from the calibration table that represents the initial (zero-hour) calibration. A corresponding error value is calculated.

In case the error is too large (i.e. larger than a pre-defined maximum acceptable error) an updated load current to be supplied to the respective LED is calculated and the input signal INᵢ is supplied to the respective LED driver may be updated accordingly. Just to give an example, it is assumed that the photo current generated by the green LED LD₂ during the initial calibration is 3.2 μA for a luminous flux of 100 lumen provided by the red LED LD₁ at a nominal load current (see first entry of table depicted in FIG. 5). It should be further assumed that during the recalibration the photo current decreased to 2.9 μA which is a factor of 1.103 (i.e., about 10%) lower. It can be concluded that the luminous flux has decreased, too, by about 10%. Consequently, the nominal load current provided to the respective LED LD₁ is increased by the factor 1.103 (i.e., by about 10%) so as to re-establish the initial luminous flux of 100 lumen.

Although the present invention and its advantages have been described in detail, it should be understood that various changes, substitutions, and alterations can be made herein without departing from the spirit and scope of the invention as defined by the appended claims.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A circuit for driving a multi-color LED assembly comprising at least two LEDs operable to emit light of different colors; the circuit comprising:
a control and processing unit configured to select a source LED and a sensor LED from the LEDs of the multi-color LED assembly;
a sensor unit associated with the sensor LED and configured to obtain a current measurement value representing a photo current provided by the sensor LED when receiving incident light emitted by the source LED; and
an LED driver unit associated with the source LED and configured to provide a load current to the source LED in accordance with a corresponding input value.

2. The circuit of claim 1, wherein the control and processing unit is configured to temporarily deactivate, during a measurement period, all other LEDs of the multi-color LED assembly except the selected source LED(s), such that only the selected source LED(s) is/are supplied with the load current.

3. The circuit of claim 1, wherein the control and processing unit is configured to receive the current measurement value and to compare it with stored calibration data, and wherein the input value is updated dependent on the comparison.

4. The circuit of claim 2, wherein the control and processing unit is configured to select all LEDs as source LEDs during normal operation where no measurements are performed.

5. The circuit of claim 3 further comprising:
a memory coupled to the control and processing unit, the calibration data being stored in the memory,
wherein the calibration data includes a mapping of load current, corresponding luminous flux, and corresponding photo current at a defined temperature for a defined calibration time.

6. A method for driving an LED assembly comprising at least two LEDs operable to emit light, the method comprising:
selecting a source LED and a sensor LED from the LEDs of the LED assembly;
providing a load current to the source LED in accordance with a corresponding input value;
obtaining a current measurement value representing a photo current provided by the sensor LED when receiving incident light emitted by the source LED.

7. The method of claim 6, further comprising, before providing the load current to the source LED, temporarily deactivating, for a measurement period, all other LEDs of the LED assembly except the selected source LED(s), such that only the selected source LED(s) can be supplied with load current.

8. The method of claim 6, further comprising:
comparing the current measurement value with stored calibration data; and
updating the input value dependent on the comparison.

9. The method of claim 7, further comprising selecting all LEDs of the LED assembly as source LEDs during normal operation where no measurements are performed.

10. The method of claim 6, wherein the LED assembly is a multi-color LED assembly including at least two LEDs operable to emit light of different colors to achieve one resulting color by additive color mixing, the method further comprising:
subsequently selecting each LED of the LED assembly as a source LED and another LED of the LED assembly as a sensor LED thus subsequently providing current measurement values representing a photo current due to the light emitted from a respective LED;
comparing each current measurement value with stored calibration data; and
updating each input value dependent on the comparison thus adjusting luminous flux provided by each individual LED to achieve a desired hue, saturation and brightness of a resulting color.

11. A circuit for driving an LED assembly comprising at least two LEDs operable to emit light, the circuit comprising:
a control and processing unit configured to select a source LED and a sensor LED from the LEDs of the LED assembly;
a sensor unit associated with the sensor LED and configured to obtain a current measurement value representing a photo current provided by the sensor LED when receiving incident light emitted by the source LED; and
an LED driver unit associated with the source LED and configured to provide a load current to the source LED in accordance with a corresponding input value.

12. The circuit of claim 11, wherein the control and processing unit is configured to temporarily deactivate, during a measurement period, all other LEDs of the LED assembly except the selected source LED(s), such that only the selected source LED(s) is/are supplied with the load current.

13. The circuit of claim 11, wherein the control and processing unit is configured to receive the current measurement value and to compare it with stored calibration data, and wherein the input value is updated dependent on the comparison.

14. The circuit of claim 12, wherein the control and processing unit is configured to select all LEDs as source LEDs during normal operation where no measurements are performed.

15. The circuit of claim 13 further comprising:
a memory coupled to the control and processing unit, the calibration data being stored in the memory,
wherein the calibration data includes a mapping of the load current, corresponding luminous flux, and corresponding photo current at a defined temperature for a defined calibration time.

16. The circuit of claim 11, wherein the LED assembly is a multi-color LED assembly including at least two LEDs operable to emit light of different colors to achieve one resulting color by additive color mixing, the control and processing unit being further configured to:
subsequently select each LED of the LED assembly as the source LED and another LED of the LED assembly as the sensor LED thus subsequently providing current measurement values representing the photo current due to the light emitted from a respective LED; and
to compare each current measurement value with stored calibration data, wherein each input value is updated dependent on the comparison thus adjusting a luminous flux provided by each individual LED to achieve a desired hue, saturation and brightness of a resulting color.

17. The circuit of claim 13, wherein the input value is updated dependent on the comparison, and wherein the update is only performed when a difference between the current measurement value and a stored desired value exceeds a predefined threshold.
